(19) United States
(12) Patent Application Publication
(10) Pub. No.: US 2011/0013076 A1
(43) Pub. Date: Jan. 20, 2011

(54) ELECTRONIC DEVICE HAVING CAMERA MODULE

(75) Inventor: CHUN-CHENG KO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/766,834

(22) Filed: Apr. 23, 2010

(30) Foreign Application Priority Data
Jul. 16, 2009 (CN) 200910304413.8

(51) Int. Cl. H04N 5/225

(52) U.S. Cl. 348/373; 348/E05.026

(57) ABSTRACT

An electronic device includes a main body defining a receiving space, a camera module comprising an outer frame, two first shafts, an inner frame, two second shafts, and an image capturing unit. The outer frame is received in the receiving space and rotatably suspended by the two first shafts. The inner frame is received within the outer frame rotatably suspended by the two second shafts, the first shafts are substantially perpendicular to the second shafts, the image capturing unit is received in the inner frame.

### BACKGROUND

1. Technical Field

The present disclosure relates to electronic devices having a camera module and, particularly, to an electronic device having a camera module capable of rotating in all directions to provide a large range for adjustable field of view.

2. Description of Related Art

Camera modules are currently used in electronic devices for various applications, for example, video instant messaging. Such camera modules are often in a fixed orientation in the electronic devices. As such, a field of view of the camera module is limited, which is not convenient for use in certain conditions.

Therefore, it is desirable to provide an electronic device having a camera module, which can overcome the abovementioned shortcomings.

### BRIEF DESCRIPTION OF THE DRAWINGS

The components in the drawing are not necessarily drawn to scale, the emphasis instead being placed upon clearly illustrating the principles of the disclosure.

FIG. 1 is an isometric view of an electronic device, according to an exemplary embodiment.

FIG. 2 is a planar view of the electronic device of FIG. 1.

FIG. 3 is an isometric view of a camera module of the electronic device of FIG. 1.

FIG. 4 is an isometric, cutaway view showing an internal structure of the camera module of FIG. 3.

FIG. 5 is an exploded view of the camera module of FIG. 3.

### DETAILED DESCRIPTION

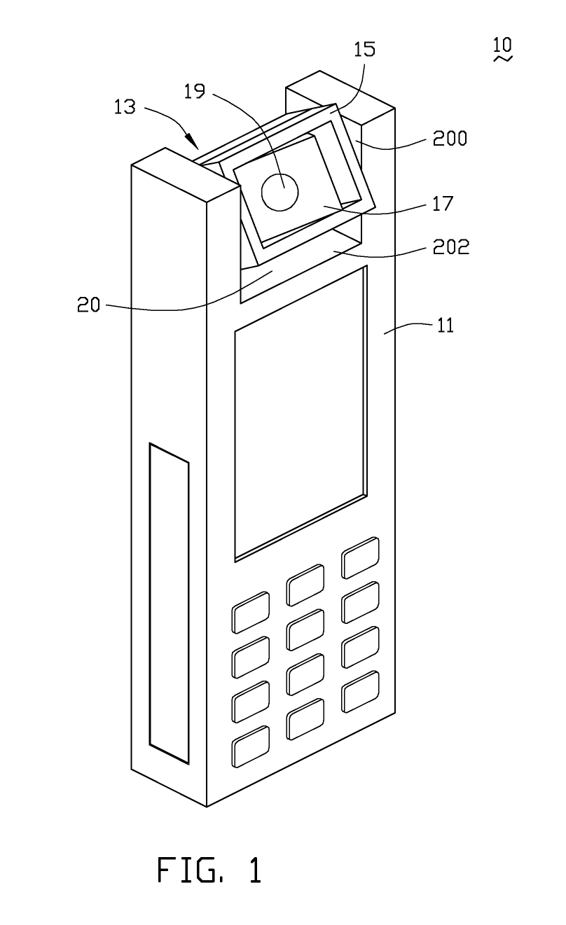

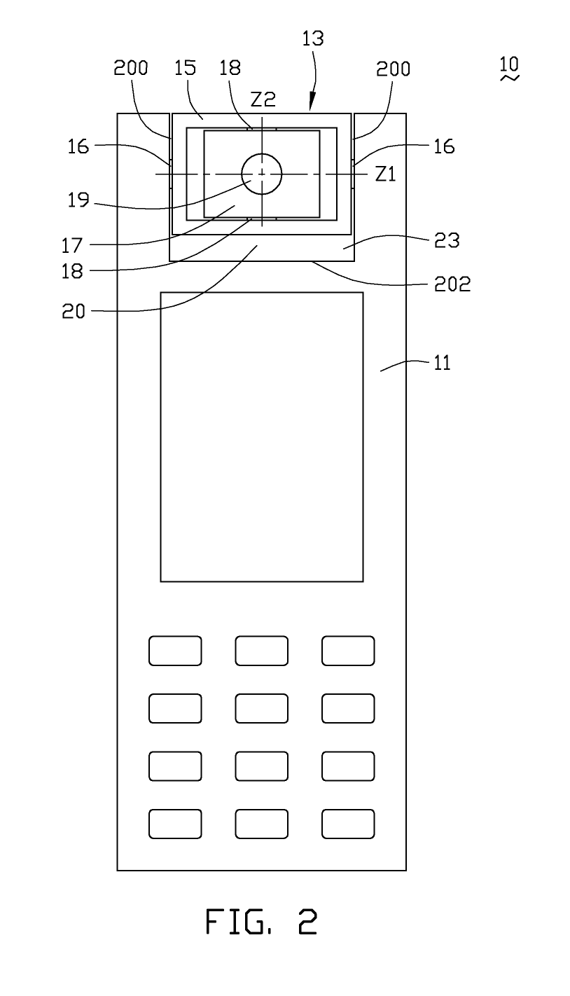

Referring to FIGS. 1 and 2, an electronic device 10, according to one exemplary embodiment, includes a main body 11 and a camera module 13. The camera module 13 includes an outer frame 15, two first shafts 16, an inner frame 17, two second shafts 18, and an image capturing unit 19. The main body 11 defines a receiving space 20 in an upper end. The camera module 13 is received in the receiving space 20 and rotatably suspended by the two first shafts 16. The inner frame 17 is received within the outer frame 15 and rotatably suspended by the two second shafts 18. The image capturing unit 19 is received in the inner frame 17. The first shafts 16 are substantially perpendicular to the second shafts 18. As such, the image capturing unit 19 can rotate 360 degrees about an axis Z1 and an axis Z2 to provide a large range for adjusting field of view. Therein, as shown in FIG. 2, the two first shafts 16 extend outwards from two opposite outer side surfaces of the outer frame 15 oppositely along the first axis Z1, the two second shafts 18 extend from two opposite outer side surfaces of the inner frame 17 oppositely along the second axis Z2, and the first axis Z1 is substantially perpendicular to the second axis Z2.

The electronic device 10 can be a cell phone, a laptop computer, or any other multimedia devices. In this embodiment, the electronic device 10 is a cell phone. The receiving space 20 can be any configuration that allows the camera module 13 to freely rotate 360 degrees. The configuration of the receiving space 20 depends on the configuration of the camera module 13, especially the outer frame 15. In the embodiment, the outer frame 15 is substantially a hollow rectangular, the receiving space 20 is recessed from an upper portion of the cell phone 10. The receiving space 20 is formed by two opposite side surfaces 200 and a bottom surface 202 connecting the two side surfaces 200. The two side surfaces 200 define two first shaft holes (not shown) aligned with each other to receive the two first shafts 16, respectively.

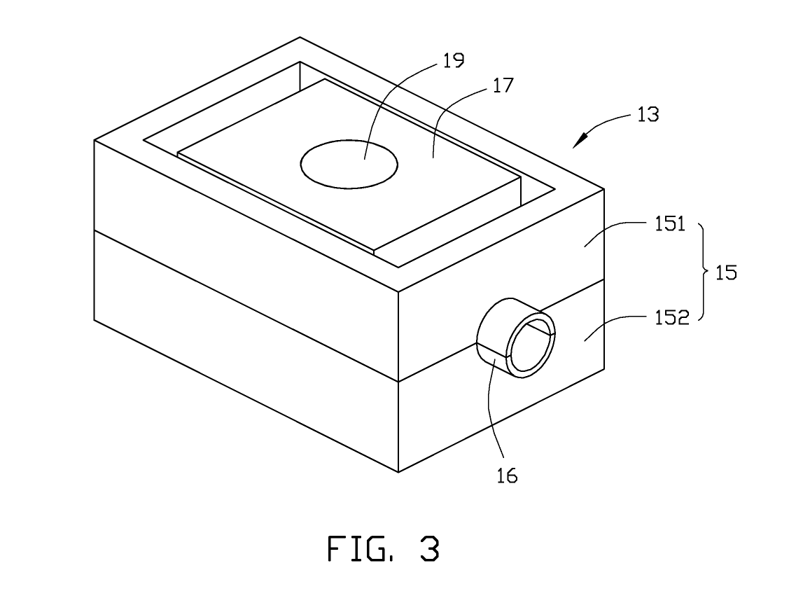

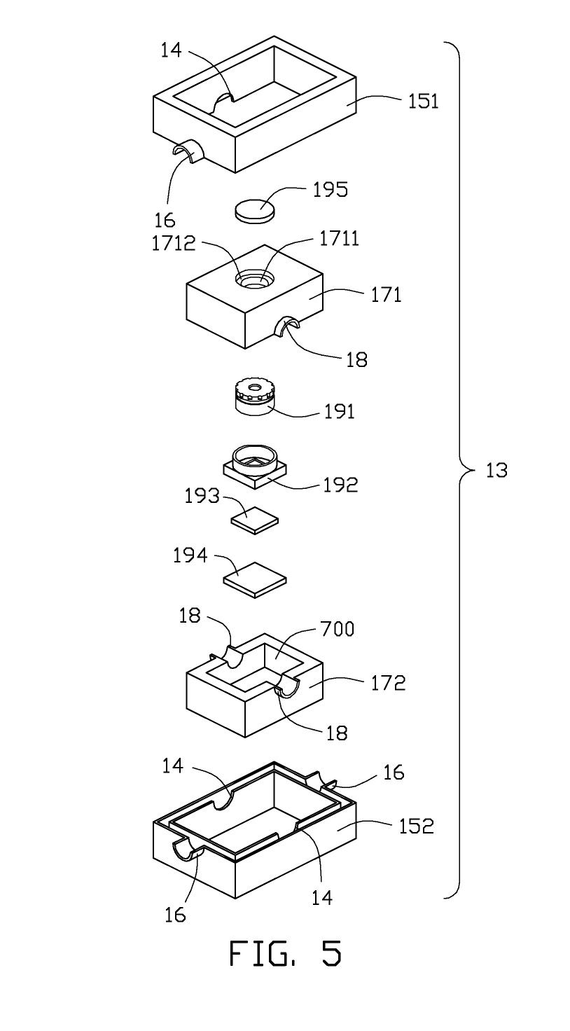

Referring also to FIGS. 3-5, the outer frame 15 is divided into two first halves 151 and 152. Each first shaft 16 is also divided into two second halves, each of which is integrally formed with the corresponding first half 151, 152 of the outer frame 15. The outer frame 15 also respectively defines two second shaft holes 14 to receive the two second shafts 18 in two opposite inner side surfaces perpendicular to the two opposite outer side surfaces of the outer frame 15. The two second shaft holes 14 are aligned with each other and extend along the second axis Z2. In the embodiment, the outer frame 15 and the first shafts 16 are hollow and define an interior space 500 to allow wires (not shown) of the image capturing unit 19 running therethrough.

The outer frame 15 is received in the receiving space 20 with a first clearance 23 formed therebetween and the first shafts 16 rotatably fit into the first shaft holes, respectively. As such, the camera module 13, i.e., the outer frame 15, is received in the receiving space 20 and is rotatable about the first shafts 16 (i.e., the first axis Z1).

In the embodiment, according to the configuration of the outer frame 15, the inner frame 17 is substantially a hollow cube, and defines an interior space 700. The inner frame 17 is also divided into two third halves 171 and 172. The two second shafts 18 extend outwards from two opposite outer side surfaces of the inner frame 17 oppositely along the second axis Z2 (see FIG. 2). Each second shaft 18 is also divided into two fourth halves, each of which is integrally formed with the corresponding third half 171/172 of the inner frame 17.

After assembly, the inner frame 17 is received in the outer frame 15 with a second clearance 600 formed therebetween and the second shafts 16 rotatably fit into the second shaft holes 14, respectively. As such, the inner frame 17 is received in the outer frame 15 and is rotatable about the second shafts 18 (i.e., the second axis Z2). In the embodiment, the second shafts 18 are hollow and the interior thereof communicates with the interior space 700 of the inner frame 17. As such, wires of the image capturing unit 19 received within the interior space 700 can run out through the second shafts 18.

Specifically, the upper third half 171 defines a first through hole 1711 and a second through hole 1712 in the upper plate thereof. The first through hole 1711 and the second through hole 1712 are coaxial and communicate with each other. The first through hole 1711 is adjacent to the interior space 700 and communicates with the interior space 700. The diameter of the first through hole 1711 is less than that of the second through hole 1712.

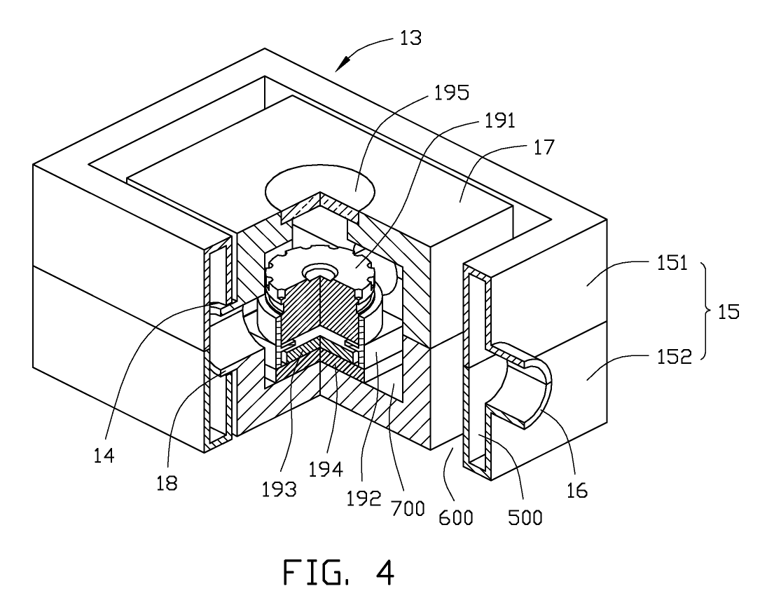

The image capturing unit 19 is received within the interior space 700 and includes a lens 191, a lens holder 192, an image sensor 193, a printed circuit board (PCB) 194, and a cover 195. The lens 191 is received in the first through hole 1711 and coupled to the lens holder 192. The image sensor 193 is received within the lens holder 192 and mechanically and electrically arranged on the PCB 194. The cover 195 seals the second through hole 1712 to protect the lens 191 from damage. Referring to FIG. 4, as discussed above, wires of the image capturing unit 19 typically extend from the PCB 194 and can go out through the interior space 700 of the inner frame 17, to the interior of the second shafts 18, to the interior space 500 of the outer frame 15, to the interior of the first shafts 16, and finally to the outside of the camera module 13 to the interior of the electronic device 10.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being or exemplary embodiments of the present disclosure.

What is claimed is:

1. An electronic device comprising:
a main body defining a receiving space,
a camera module comprising an outer frame, two first shafts, an inner frame, two second shafts, and an image capturing unit, the outer frame being received in the receiving space and rotatably suspended by the two first shafts;
wherein the inner frame is received within the outer frame and rotatably suspended by the two second shafts, the first shafts are substantially perpendicular to the second shafts, the image capturing unit is received in the inner frame.

2. The electronic device according to claim 1, wherein the receiving space is formed by two opposite side surfaces of the main body and a bottom surface of the main body connecting the two side surfaces, the two side surfaces define two first shaft holes aligned with each other to receive the two first shafts, respectively.

3. The electronic device according to claim 2, wherein the outer frame and the first shafts are hollow and define an interior space to allow wires of the image capturing unit running therethrough.

4. The electronic device according to claim 3, wherein the outer frame is received in the receiving space with a first clearance formed between the outer frame and the receiving space, and the first shafts rotatably fit into the first shaft holes respectively, thereby the outer frame is received in the receiving space and rotatable about the first shafts.

5. The electronic device according to claim 3, wherein the second shafts are hollow and the interior thereof communicate with the interior space, thereby the wires of the image capturing unit received within the interior space can run out through the second shafts.

6. The electronic device according to claim 3, wherein the inner frame is received in the outer frame with a second clearance formed between the outer frame and the inner frame, and the second shafts rotatably fit into the second shaft holes respectively, thereby the inner frame is received in the outer frame and rotatable about the second shafts.

7. The electronic device according to claim 3, wherein the inner frame defines a first through hole and a second through hole in an upper plate, the first through hole and the second through hole are coaxial and communicate with each other, the first through hole is adjacent to the interior space and communicates with the interior space, the diameter of the first through hole is less than that of the second through hole.

8. The electronic device according to claim 7, wherein the image capturing unit comprises a lens, a lens holder, an image sensor, and a printed circuit board (PCB), the lens is received in the first through hole and coupled to the lens holder, the image sensor is received with lens holder and mechanically and electrically disposed on the PCB.

9. The electronic device according to claim 8, wherein the image capturing unit further comprises a cover for sealing the second through hole to protect the lens from damage.

10. The electronic device according to claim 8, wherein the wires of the image capturing unit extend from the PCB and go out through the interior space of the inner frame, to the interior of the second shafts, to the interior space of the outer frame, to the interior of the first shafts, and finally to the outside of the camera module to the interior of the electronic device.

11. The electronic device according to claim 1, wherein the outer frame is substantially a hollow rectangular tube.

12. The electronic device according to claim 1, wherein the receiving space is recessed from an upper portion of the electronic device.

13. The electronic device according to claim 1, wherein the inner frame is substantially a hollow cube.
